(19) United States
(12) Patent Application Publication
(10) Pub. No.: US 2026/0082384 A1
(43) Pub. Date: Mar. 19, 2026

(54) DEVICE AND METHOD FOR SEMI PERSISTENT SCHEDULING FOR MULTI-FLOW XR COMMUNICATIONS

(71) Applicant: Lenovo (Singapore) Pte. Ltd., Singapore (SG)

(72) Inventors: Joachim LOHR, Wiesbaden (DE); Prateek BASU MALLICK, Dreieich (DE); Hyung-Nam CHOI, Ottobrunn (DE); Ravi KUCHIBHOTLA, Chicago, IL (US)

(21) Appl. No.: 19/109,761

(22) PCT Filed: Sep. 21, 2023
(86) PCT No.: PCT/IB2023/059366

§ 371 Date: Mar. 7, 2025

Related U.S. Application Data
(60) Provisional application No. 63/376,726, filed on Sep. 22, 2022.

(51) Int. Cl. H04W 72/11; H04W 72/23

(52) U.S. Cl. CPC H04W 72/11; H04W 72/23

(57) ABSTRACT

Various aspects of the present disclosure relate to a method for wireless communication that includes receiving a first downlink semi-persistent scheduling configuration over radio resource control signaling, wherein the first semi-persistent scheduling configuration includes a set of identifiers that identify at least one other downlink semi-persistent scheduling configuration associated with the first downlink semi-persistent scheduling configuration. User equipment may use the scheduling configuration to temporarily disable decoding semi-persistent scheduling occasions associated with a failed occasion.

### CROSS REFERENCE TO RELATED APPLICATIONS

This application is a national phase entry of International Application No. PCT/IB2023/059366, filed Sep. 21, 2023, which claims priority to U.S. Provisional Patent Application No. 63/376,726, filed on Sep. 22, 2022, entitled DEVICE AND METHOD FOR SEMI PERSISTENT SCHEDULING FOR MULTI-FLOW XR COMMUNICATIONS, which are hereby incorporated by reference in their entirety.

### TECHNICAL FIELD

The present disclosure relates to wireless communications, and more specifically to efficient extended Reality (XR) communications.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

XR is an umbrella term for different types of realities. One type of extended reality is virtual reality (VR), which is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually present to allow the simulated visual and audio components to be updated in order to ensure that, from the user's perspective, items and sound sources remain consistent with the user's movements. Additional ways to interact with the virtual reality simulation may be provided. Augmented reality (AR) is an extended reality when a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed. Mixed reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partial sensory inputs to fully immersive VR. A key aspect of XR is the extension of human experiences especially relating to the senses of existence (represented by VR) and the acquisition of cognition (represented by AR).

Many of the XR use cases are characterized by quasi-periodic traffic (with possible jitter) with a high data rate in downlink for a video stream combined with frequent uplink transmissions for pose and control updates and uplink video streams. Both downlink and uplink traffic for XR are also characterized by relatively strict packet delay budgets (PDB).

### SUMMARY

The present disclosure relates to methods, apparatuses, and systems that support configurations for XR communications and using the configurations to save power.

Some implementations of the method and apparatuses described herein may further include UE for wireless communication, at least one processor coupled with the at least one memory and configured to cause the UE to receive a first downlink semi-persistent scheduling (SPS) configuration over radio resource control signaling, wherein the first SPS configuration includes a set of identifiers that identify at least one other downlink SPS configuration associated with the first downlink SPS configuration.

In some implementations of the method and apparatuses described herein, the processor is further configured to detect a failure to receive a physical downlink shared channel (PDSCH) transmission occasion of the first SPS configuration, and in response to the detected failure, disable the decoding of at least one PDSCH transmission on a SPS transmission occasion of the at least one other downlink SPS configuration identified by the set of identifiers for a predetermined time period.

The processor may be further configured to cause the UE to enable decoding of the of SPS transmission occasions of the at least one other downlink SPS configuration identified by the set of identifiers after the predetermined time period. The predetermined time period may be the next occurrence of a PDSCH transmission of the first SPS configuration.

In an embodiment, the first SPS configuration designates a primary SPS configuration and at least one secondary SPS configuration, and the predetermined time period is the next occurrence of a transmission of the primary SPS configuration. The processor may be further configured to cause the UE to disable the decoding of all PDSCH transmission occasions for the at least one secondary SPS configuration after detecting a failure of a PDSCH transmission occasion of the primary SPS configuration for the predetermined time period.

In an embodiment, the UE detects the failure to receive the PDSCH transmission occasion when the apparatus does not detect a PDSCH transmission on a semi-persistent transmission occasion of the first SPS configuration.

Each configuration of the first SPS configuration and the at least one other downlink SPS configuration associated with the first SPS configuration may be for a mixed reality (XR) communication. Each SPS configuration may be associated with a different sensory channel, and the different sensory channels may include a video channel and an audio channel.

In other embodiments, a processor for wireless communication includes at least one memory and a controller coupled with the at least one memory and configured to cause the controller to receive a first downlink SPS configuration over radio resource control signaling, wherein the first SPS configuration includes a set of identifiers that identify at least one other downlink SPS configuration associated with the first downlink SPS configuration. The controller may be further configured in a similar manner to the processor of the UE described above.

In an embodiment, a method performed by a UE includes receiving a first downlink SPS configuration over radio resource control signaling, wherein the first SPS configuration includes a set of identifiers that identify at least one other downlink SPS configuration associated with the first downlink SPS configuration. The method may further include detecting a failure to receive a PDSCH transmission occasion of the first SPS configuration; and in response to the detected failure, disabling decoding of at least one PDSCH transmission on a SPS transmission occasion of the at least one other downlink SPS configuration identified by the set of identifiers for a predetermined time period.

### BRIEF DESCRIPTION OF THE DRAWINGS

FIG. 1 illustrates an example of a wireless communications system that supports efficient XR communications in accordance with aspects of the present disclosure.

FIG. 2 illustrates an example of a block diagram of a device that supports efficient XR communications in accordance with aspects of the present disclosure.

FIG. 3 illustrates a flowchart of a method that supports efficient XR communications in accordance with aspects of the present disclosure.

FIG. 4 illustrates an example of an SPS configuration information element that supports efficient XR communications in accordance with aspects of the present disclosure.

FIG. 5 illustrates an example of a configured grant (CG) configuration information element that supports efficient XR communications in accordance with aspects of the present disclosure.

FIGS. 6A and 6B illustrate examples of related XR communication flows in accordance with aspects of the present disclosure.

FIG. 7 illustrates a flowchart of a method that supports efficient XR communications in accordance with aspects of the present disclosure.

FIG. 8 illustrates an example of a block diagram of a processor that supports efficient XR communications in accordance with aspects of the present disclosure.

### DETAILED DESCRIPTION

XR and related services have a certain variety and characteristics of the data streams (e.g., video) may change “on-the-fly” while the services are running over New Radio (NR). Therefore, additional information on the running services from higher layers, e.g. the QoS flow association, frame-level QoS, application data unit (ADU)-based or protocol data unit (PDU) set based QoS, XR specific QoS etc., may be beneficial to facilitate informed choices of radio parameters. XR application awareness by UEs and gNBs can improve the user experience, improve the NR system capacity in supporting XR services, and reduce the UE power consumption.

Connected mode discontinuous reception (C-DRX) can be used to help XR devices save power, and hence operate longer without needing to be charged, or otherwise reduce overall energy consumption. However, XR traffic characteristics, such as non-integer traffic periodicity and jitter can result in missing an opportunity to schedule an XR video frame within an on-duration time of a DRX cycle. For instance, the video frame may arrive after the on-duration, and hence is scheduled in the next DRX cycle, which in turn increases the associated latency. Such latency increase may not be desirable as XR packets delivered outside a delay budget otherwise may be useless.

For XR services where an XR application has multiple flows with different traffic characteristics semi-persistent scheduling (SPS) could be used to help schedule transmission corresponding to different traffic in a timely manner when using a single DRX configuration. Multiple simultaneous DRX configurations, each matching a traffic flow, is suitable to achieve both high UE power saving gains and many satisfied UEs, if a single DRX configuration matched to one flow does not satisfy the PDBs of other flows. However, enabling multiple simultaneously active DRX configurations comes at the expense of a higher complexity and also involves further enhancements and standardization efforts. On the other hand, providing SPS occasions according to expected traffic arrivals can result in system improvements.

A multi-modal XR application typically has multiple interdependent flows with different traffic characteristics, e.g., corresponding to different human senses (audio, video, haptics, etc.). These new emerging XR services use synchronized parallel flows to arrive to the user for a proper service experience. Due to their quasi-periodic nature, data of the different flows of a multi-modal XR application can be mapped to different SPS configurations for the downlink (DL). According to the current defined behavior a UE tries to decode PDSCH(s) on an SPS configuration regardless of whether there was DL data on one of the SPS occasions carrying the data of the other flows of a multi-modal application. Since the user can only enjoy the full experience when the UE receives the data of all flows, there is limited value in further receiving data of the flows when no data for one of the flows is detected. For example, if only haptic data is available but video and audio data is absent, the quality of the experience is substantially reduced, and efficiency can be increased by not decoding the haptic data for which the associated video and audio data is absent.

An ADU is the smallest unit of data that can be processed independently by an application, such as processing for handling out-of-order traffic data. A video frame can be an I-frame, P-frame, or can be composed of I-slices, and/or P-slices. I-frames/I-slices are more important and larger than P-frames/P-slices. An ADU can be one or more I-slices, P-slices, I-frame, P-frame, or a combination of those. It should be noted that the term PDU set can be interchangeably used for the term ADU with respect to the scope of this disclosure.

A service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient XR service delivery by satisfying XR service requirements for a greater number of UEs, or by UE power savings.

The latency requirement of XR traffic on the RAN side (air interface) is modelled as packet delay budget (PDB). The PDB is a limited time budget for a packet to be transmitted over the air from a gNB to a UE.

For a given packet, the delay of the packet in the air interface is measured from the time that the packet arrives at the gNB to the time that it is successfully transferred to the UE. If the delay is larger than a given PDB for the packet, then the packet violates the PDB, otherwise the packet is considered to be successfully delivered. The value of PDB may vary for different applications and traffic types, which can be 10-20 ms depending on the application, as explained in TR 26.926.

According to R1-2112245, 5G arrival time of data bursts on the downlink can be quasi periodic i.e. periodic with jitter. Some of the factors leading to jitter in burst arrival include varying server render time, encoder time, RTP packetization time, link between server and 5G gateway etc. 3GPP agreed simulation assumptions for XR evaluation model DL traffic arrival jitter using truncated Gaussian distribution with mean: 0 ms, std. dev: 2 ms, range: [−4 ms, 4 ms] (baseline), [−5 ms, 5 ms] (optional).

Applications can have a certain delay requirement on an ADU, that may not be adequately translated into packet delay budget requirements. For example, if the ADU delay budget (ADB) is 10 ms, then the PDB can be set to 10 ms only if all packets of the ADU arrive at the 5G system at the same time. If the packets are spread out, then ADU delay budget is measured either in terms of the arrival of the first packet of the ADU or the last packet of the ADU. In either case, a given ADB will result in different PDB requirements on different packets of the ADU. Specifying the ADB to the 5G system can be beneficial.

If the scheduler, and/or the UE is aware of delay budgets for a packet/ADU, the gNB can take this knowledge into account in scheduling transmissions, for example, by giving priority to transmissions close to their delay budget limit, and by not scheduling (e.g., UL) transmissions. The UE can also take advantage of such knowledge to determine 1) if an UL transmission (e.g., PUCCH in response to PDSCH, UL pose, or PUSCH) corresponding to a transmission that exceeds its delay budget can be dropped, and in addition, that there is no need to wait for re-transmission of a PDSCH and no need to keep the erroneously received PDSCH in a buffer for soft combining with a re-transmission that never occurs, and 2) how much of its channel occupancy time when using unlicensed spectrum can be shared with the gNB.

The remaining delay budget 1) for a DL transmission can be indicated to the UE in downlink control information (DCI) (e.g., for a packet of a video frame/slice/ADU) or via a MAC-CE (e.g., for an ADU/video frame/slice) and 2) for an UL transmission can be indicated to the gNB via an UL transmission such as uplink control information (UCI), a physical uplink shared channel (PUSCH) transmission, etc.

ADU-related QoS aspects of XR can be conveyed to the RAN to optimize the communication such as ADU error rate (AER), ADU delay budget (ADB), and ADU content policy (referred to as ADP, which is a percentage of packets/bits of an ADU to be received in order to correctly decode the ADU).

The present disclosure provides embodiments of solutions that provide power saving gains for XR multi-modal applications. The concept of associated SPS configurations is introduced. Certain defined UE behavior for receiving PDSCH on SPS occasions of associated SPS configurations are detailed in this disclosure. For example, for cases in which there is no PDSCH transmission on a SPS occasion for one SPS configuration of the group of associated SPS configurations detected, a UE can temporarily disable the reception of PDSCH for the other SPS configurations in the group of associated SPS configurations. This achieves some additional power saving gain and reduces processor load, heat generation, etc. of a UE.

Aspects of the present disclosure are described in the context of a wireless communications system. Aspects of the present disclosure are further illustrated and described with reference to device diagrams and flowcharts.

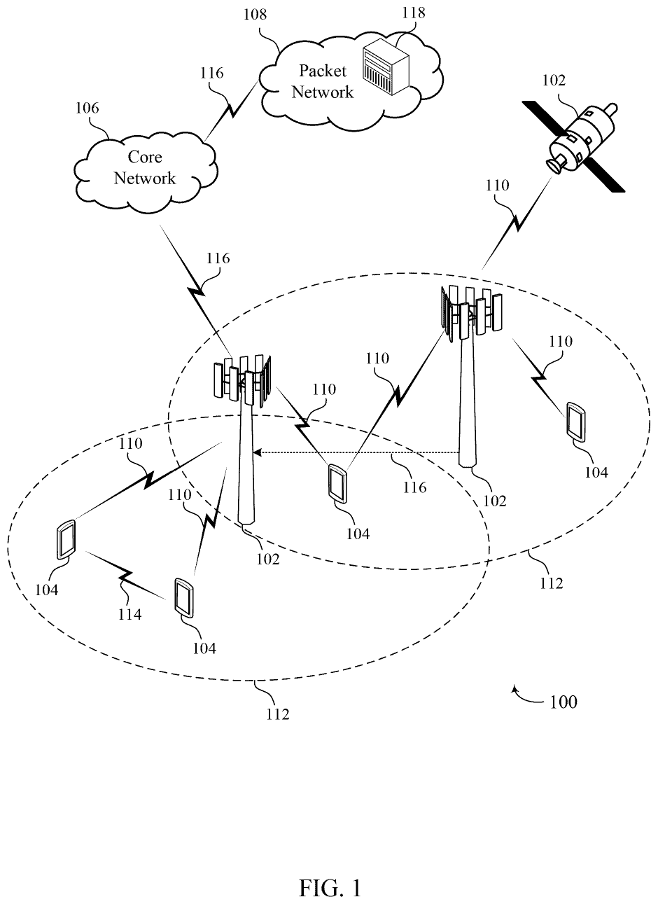

FIG. 1 illustrates an example of a wireless communications system 100 that supports efficient XR communications in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, (=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

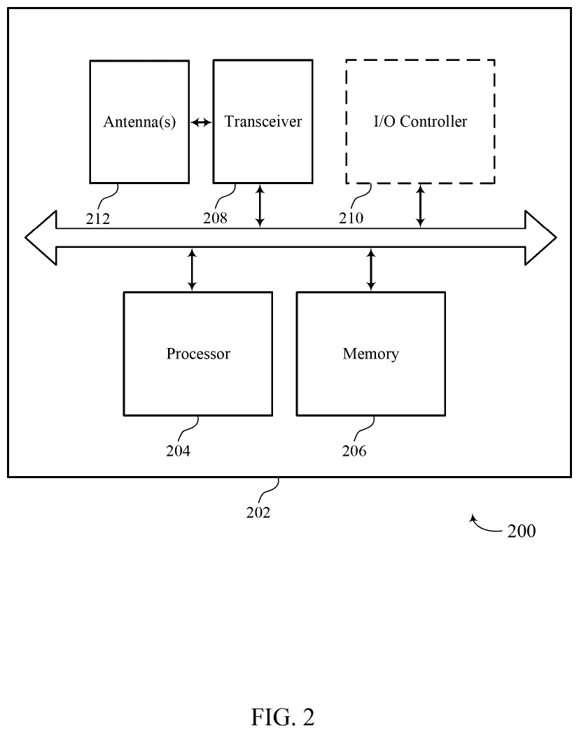

FIG. 2 illustrates an example of a block diagram 2 of a device 202 that supports efficient XR communications in accordance with aspects of the present disclosure. The device 202 may be an example of a network entity 102 or a UE 104 as described herein. The device 202 may support wireless communication with one or more network entities 102, UEs 104, or any combination thereof. The device 202 may include components for bi-directional communications including components for transmitting and receiving communications, such as a processor 204, a memory 206, a transceiver 208, and an I/O controller 210. These components may be in electronic communication or otherwise coupled (e.g., operatively, communicatively, functionally, electronically, electrically) via one or more interfaces (e.g., buses).

The processor 204, the memory 206, the transceiver 208, or various combinations thereof or various components thereof may be examples of means for performing various aspects of the present disclosure as described herein. For example, the processor 204, the memory 206, the transceiver 208, or various combinations or components thereof may support a method for performing one or more of the operations described herein.

In some implementations, the processor 204, the memory 206, the transceiver 208, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 204 and the memory 206 coupled with the processor 204 may be configured to perform one or more of the functions described herein (e.g., executing, by the processor 204, instructions stored in the memory 206).

For example, the processor 204 may support wireless communication at the device 202 in accordance with examples as disclosed herein. Processor 204 may be configured as or otherwise support efficient XR communications.

The processor 204 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 204 may be configured to operate a memory array using a memory controller. In some other implementations, a memory controller may be integrated into the processor 204. The processor 204 may be configured to execute computer-readable instructions stored in a memory (e.g., the memory 206) to cause the device 202 to perform various functions of the present disclosure.

The memory 206 may include random access memory (RAM) and read-only memory (ROM). The memory 206 may store computer-readable, computer-executable code including instructions that, when executed by the processor 204 cause the device 202 to perform various functions described herein. The code may be stored in a non-transitory computer-readable medium such as system memory or another type of memory. In some implementations, the code may not be directly executable by the processor 204 but may cause a computer (e.g., when compiled and executed) to perform functions described herein. In some implementations, the memory 206 may include, among other things, a basic I/O system (BIOS) which may control basic hardware or software operation such as the interaction with peripheral components or devices.

The I/O controller 210 may manage input and output signals for the device 202. The I/O controller 210 may also manage peripherals not integrated into the device M02. In some implementations, the I/O controller 210 may represent a physical connection or port to an external peripheral. In some implementations, the I/O controller 210 may utilize an operating system such as iOS®, ANDROID®, MS-DOS®, MS-WINDOWS®, OS/2®, UNIX®, LINUX®, or another known operating system. In some implementations, the I/O controller 210 may be implemented as part of a processor, such as the processor 204. In some implementations, a user may interact with the device 202 via the I/O controller 210 or via hardware components controlled by the I/O controller 210.

In some implementations, the device 202 may include a single antenna 212. However, in some other implementations, the device 202 may have more than one antenna 212 (i.e., multiple antennas), including multiple antenna panels or antenna arrays, which may be capable of concurrently transmitting or receiving multiple wireless transmissions. The transceiver 208 may communicate bi-directionally, via the one or more antennas 212, wired, or wireless links as described herein. For example, the transceiver 208 may represent a wireless transceiver and may communicate bi-directionally with another wireless transceiver. The transceiver 208 may also include a modem to modulate the packets, to provide the modulated packets to one or more antennas 212 for transmission, and to demodulate packets received from the one or more antennas 212.

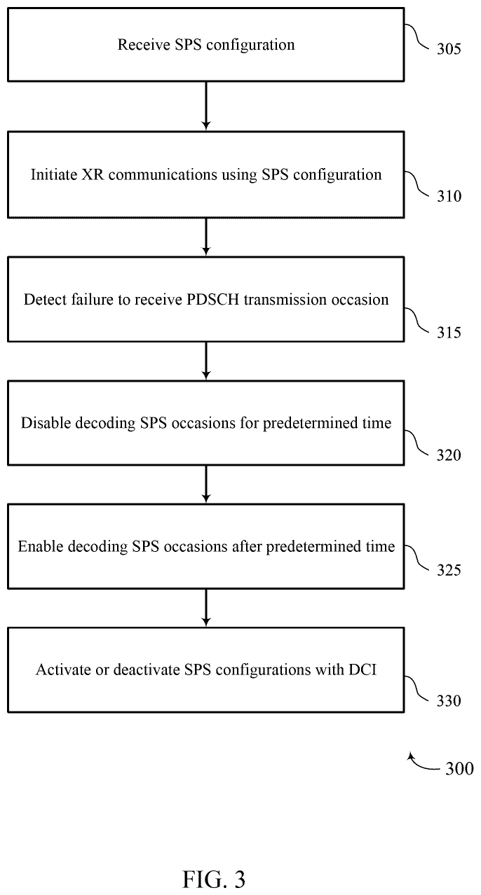

FIG. 3 illustrates a flowchart of a method 300 that supports efficient XR communications in accordance with aspects of the present disclosure. The operations of the method 300 may be implemented by a device or its components as described herein. For example, elements of the method 300 may be performed by a network entity 102 or a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 305, the method may include receiving an SPS configuration. The operations of 305 may be performed in accordance with examples as described herein. In some implementations, aspects of the operations of 305 may be performed by a device as described with reference to FIG. 1.

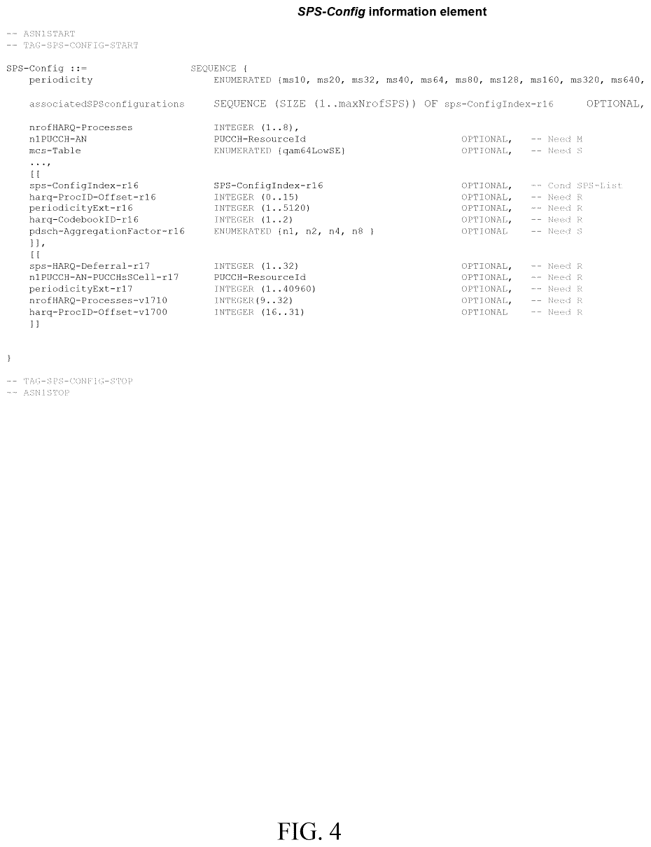

In an embodiment, the SPS configuration is received by a UE 104 using RRC control signaling. For example, the SPS configuration may be transmitted from a base station to one or more UE as an information element on a control channel. FIG. 4 illustrates an example of an information element (IE) that communicates an SPS configuration (SPS-Config) that supports efficient XR communications in accordance with aspects of the present disclosure.

As illustrated in FIG. 4, an SPS configuration may indicate a set of associated SPS configurations. According to one implementation, an SPS configuration contains a new field which configures, if present, a list of identifiers, identifying associated SPS configurations. In one example, the network may configure a set of associated SPS configurations based on signaling information received from the Core Network, e.g. by a session management function (SMF).

To support multi-modal applications efficiently, an application function (AF) may provide a service flow coordination group ID together with group level treatment requirements to the policy control function (PCF). This information of the associated services flows belonging to a multi-modal XR application may be further propagated to the RAN to allow a gNB scheduler to efficiently perform resource allocation tasks as well as admission control. According to one implementation, the information of associated SPS configurations, which may be derived from the information of associated service flows provided by the Core network, is used by the UE 104 to further enhance power saving for XR applications as well as provide capacity gains.

In an embodiment, an SPS configuration includes a group identifier, wherein the group identifier defines a group of associated SPS configurations. Each SPS configuration which is part of the group of associated SPS configurations has been configured with the same group identifier.

In addition, the SPS configuration received at 305 may designate an SPS configuration of a set of associated SPS configurations as a primary SPS configuration, and the other SPS configurations in the set may be designated as secondary SPS configurations. The significance of these designations will be discussed in further detail below.

At 310, the method may include initiating XR communications based on the SPS configuration received at 305. The operations of 305 may be performed in accordance with examples as described herein. In some implementations, aspects of the operations of 305 may be performed by a device as described with reference to FIG. 1.

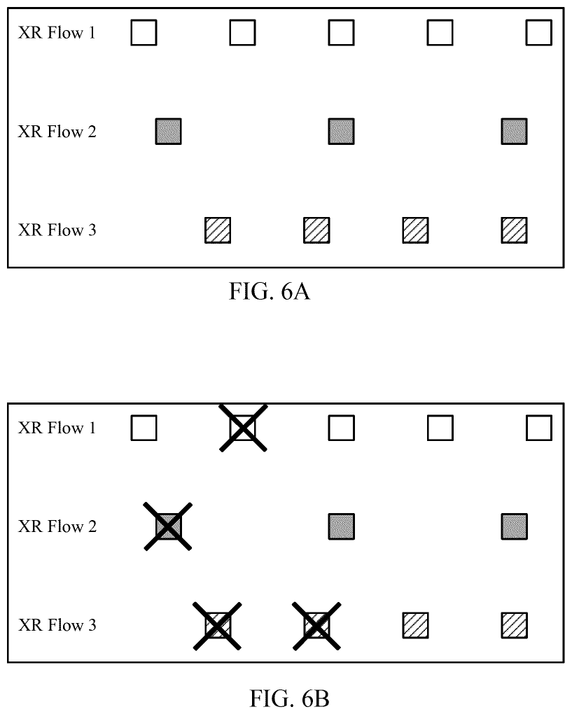

FIG. 6A illustrates an embodiment of XR communications using three different XR data flows. The XR data flows may have different offsets which are indicated in the SPS configuration element. In FIG. 6A, XR Flow 1 has a first offset, XR Flow 2 has a second offset that is greater than the first offset, and XR Flow 3 has a third offset that is greater than the second offset. Each XR Flow may communicate sense data, such as video, audio and haptic data, and each sense data may have parameters such as QoS, packet size, periodicity, etc. that are different from at least one of the other XR traffic flows. Each of the boxes in FIG. 6A may represent one or more associated packet of data, which may otherwise be referred to as an SPS occasion.

At 315, the method may include detecting a failure to successfully receive a PDSCH transmission occasion. The operations of 315 may be performed in accordance with examples as described herein. In some implementations, aspects of the operations of 315 may be performed by a device as described with reference to FIG. 1.

A UE 104 may detect a failure to successfully receive a PDSCH transmission occasion by failing to detect a PDSCH signal at the time and frequency designated for an XR traffic flow. In other words, the UE 104 may detect a failure to receive a PDSCH transmission, or SPS occasion, when the UE does not receive the PDSCH transmission at all, which could be a result, for example, of a transmission failure of a base station or a hardware failure of the UE.

In another embodiment, the UE may detect a failure to receive a PDSCH when the UE fails to successfully decode a PDSCH transmission within the PDB for the transmission. This could result, for example, when the radio environment is too noisy for the UE to successfully decode a transmission even after potential retransmission attempts. Accordingly, a failure to receive a PDSCH transmission occasion may occur when no transmission is received, or when a transmission is received but not successfully processed within a PDB.

At 320, the method may include disabling the decoding of SPS occasions for a predetermined time, and decoding of SPS occasions is enabled after the predetermined time at 325. The operations of 320 and 325 may be performed in accordance with examples as described herein. In some implementations, aspects of the operations of 320 and 325 may be performed by a device as described with reference to FIG. 1.

According to an embodiment, a UE 104 skips monitoring and/or decoding the PDSCH and/or PDCCH on an SPS transmission occasion when no PDSCH was detected on a SPS transmission occasion of an associated SPS configuration. For example, the UE 104 disables decoding SPS occasions associated with the failed PDSCH transmission occasion that was detected at 315. In an embodiment, the UE 104 does not try to decode a PDSCH on an SPS transmission occasion when the UE 104 did not detect any PDSCH transmission on a preceding SPS transmission occasion of an associated SPS configuration.

In an embodiment, disabling decoding SPS occasions at 320 includes temporarily disabling the reception of data on an SPS configuration when the UE 104 did not detect a downlink data transmission for an associated flow/SPS configuration, which results in increased power savings for XR applications.

When different flows (logical channel (LCH) or data radio bearer (DRB)) of a multi-flow XR application, e.g. a multi-modal application, are mapped to different associated SPS configurations, the UE 104 may temporarily stop the reception of data on the other associated SPS configurations when the UE 104 has not received any data on one of the SPS transmission occasions of the group of associated SPS configurations. For example, the processor 204 of the UE 104 may disable receiving/decoding the SPS occasions for a predetermined time, the data of the SPS occasions may not be stored in memory 206, and/or the transceiver 208 may be disabled from processing the data of the SPS occasions.

When data of one of the input signals of a multi-modal application has not been transmitted/received in downlink, there is little or no benefit in receiving data of the other input signals of the XR applications. Instead, the UE 104 saves power by not even trying to decode the other data associated with the failed PDSCH transmission occasion.

An embodiment of disabling the decoding of SPS occasions for a predetermined time at 320 is illustrated in FIG. 6B. In the embodiment shown in FIG. 6B, the UE 104 detects a failure to receive the first PDSCH transmission occasion of XR Flow 2. The UE 104 then disables decoding of the associated SPS configurations of XR Flow 1 and XR Flow 3, which are crossed out in the figure, and resumes decoding at the next SPS occasion of XR Flow 2. In various embodiments, the predetermined time can have different configurations.

In an embodiment, the UE 104 does not decode the PDSCH and/or PDCCH on SPS transmission occasions of other associated SPS configurations of the group of associated SPS configurations for a predetermined time after the failure to receive the PDSCH transmission occasion of one of the group of associated SPS configurations was detected at 315. In one example the predetermined time corresponds to one SPS period.

According to one embodiment, the UE 104 stops decoding the PDSCH and/or PDCCH on SPS transmission occasions of other associated SPS configurations until the next SPS transmission occasion of the SPS configuration where PDSCH reception failed. An example of such an embodiment will be explained with respect to FIG. 6B.

As seen in FIG. 6B, a UE 104 fails to decode the PDSCH on the first SPS transmission occasion of the second SPS configuration (XR-flow 2). The failure triggers the UE 104 to stop monitoring the PDSCH and/or PDCCH of the other associated SPS configurations. In FIG. 6B, the configurations include a first SPS which corresponds to XR-flow 1 and a third SPS configuration which corresponds to XR-flow 3. As shown in FIG. 6B, the UE 104 disables decoding of the SPS transmission occasion of the first SPS configuration (XR-flow 1) and the next two SPS transmission occasion of the third SPS configuration (XR-flow 3). The UE 104 enables PDSCH and/or PDCCH decoding (applying legacy behavior) starting with the second SPS transmission occasion of the second SPS configuration (XR-flow 2) at 325.

In another embodiment, the UE 104 disables decoding PDSCH and/or PDCCH occasions on the next SPS transmission occasion of the associated SPS configurations when a failure to receive a PDSCH occasion was detected at 315. In other words, one SPS transmission occasion for each of the associated SPS configurations is disabled for PDSCH and/or PDCCH decoding. In such an embodiment, with respect to FIG. 6B, the first occasion of XR Flow 3 and the second occasion of XR Flow 1 would be skipped after the first occasion of XR Flow 2 fails, and decoding would resume for the second occasion of XR Flow 3.

In another embodiment, the predetermined time is linked to a timer which is configured to run for the predetermined time. For example, the UE 104 may start a timer in response to detecting a failed PDSCH transmission on an SPS transmission occasion. In one implementation, UE 104 does not decode PDSCH and/or PDCCH on the SPS transmission occasions of the group of associated SPS configurations as long as the timer is running, for example by disabling PDSCH and/or PDCCH decoding for all SPS transmission occasions of the group. An example of a time duration of the timer is 10 ms, but other times can be used.

Upon expiration of the timer, the UE 104 enables the PDSCH and/or PDCCH decoding on the SPS transmission occasions at 325—in other words, the UE 104 applies legacy behavior after the timer expires. In one example the timer value is preconfigured or fixed according to a standard. In some embodiments, the timer value is configured in an SPS configuration, for example by an indication in an SPS-Config IE.

As noted above, in an embodiment, one SPS configuration of a set of associated SPS configurations is configured as a primary SPS configuration when the SPS configuration is received at 305. In one implementation, the other SPS configurations of the set of associated SPS configurations are defined as secondary SPS configurations. The UE 104 may stop decoding the PDSCH and/or PDCCH on SPS transmission occasions of the group of associated SPS configurations until the next SPS transmission occasion of the primary SPS configuration when the PDSCH occasion failed on a SPS transmission occasion of one of the group of associated SPS configurations at 315. In such an embodiment, the predetermined time of 320 is the time until the next SPS transmission occasion of the primary SPS configuration. In an embodiment, the SPS configuration for video data is designated as the primary SPS configuration for a multi-modal XR application.

According to one embodiment, a UE 104 is configured to disable or not disable decoding of SPS transmission occasions of other associated SPS configurations after a failed PDSCH transmission was detected on a SPS transmission occasion of one of the group of associated SPS configurations at 315. The configuration may be signaled by higher layer signaling like RRC signaling, for example as part of the SPS configuration. In one implementation, the configuration may be signaled by a DCI, e.g. an SPS activation DCI, or MAC control element (CE) signaling.

At 330, the method may include activating or deactivating SPS configurations with a DCI. The operations of 330 may be performed in accordance with examples as described herein. In some implementations, aspects of the operations of 330 may be performed by a device as described with reference to FIG. 1. Although 330 is presented as the final element of the flowchart in FIG. 3, the activation or deactivation can be performed any time after SPS configurations are received at 305.

According to an embodiment, a singe DCI indicating the activation or deactivation of a SPS configuration which is part of a group of associated SPS configurations activates or deactivates the complete group of SPS configurations. According to one implementation, a UE 104 activates or deactivates SPS configurations in response to receiving SPS activation or deactivation DCI for a single SPS configuration which is configured with one or more associated SPS configuration. That is, the DCI activates or deactivates not only the SPS configuration indicated by the DCI, but also the SPS configurations which are configured as associated SPS configurations.

In an embodiment, a DCI indicating the activation or deactivation of an SPS configuration includes a new field indicating whether UE 104 shall also activate or deactivate the associated SPS configurations. Accordingly, the DCI may include an indication to activate or deactivate an SPS configuration, and the UE 104 may be configured to activate or deactivate all associated SPS configurations based on the indication.

According to one implementation, UE 104 activates in response to receiving SPS activation DCI for an SPS configuration which is configured with a set of associated SPS configuration not only the SPS configuration indicated by the DCI but also the SPS configurations which are configured as associated SPS configurations, wherein the associated SPS configuration are activated with a given time offset. In one example the DCI indicates the time offsets for the associated SPS configurations. In another embodiment, the SPS configuration is configured with one or more time offset to be applied for activation of respective associated SPS configurations.

Although process 300 has been explained with respect to downlink communications and SPS, the same principles and techniques can be applied to uplink (UL) communications as well.

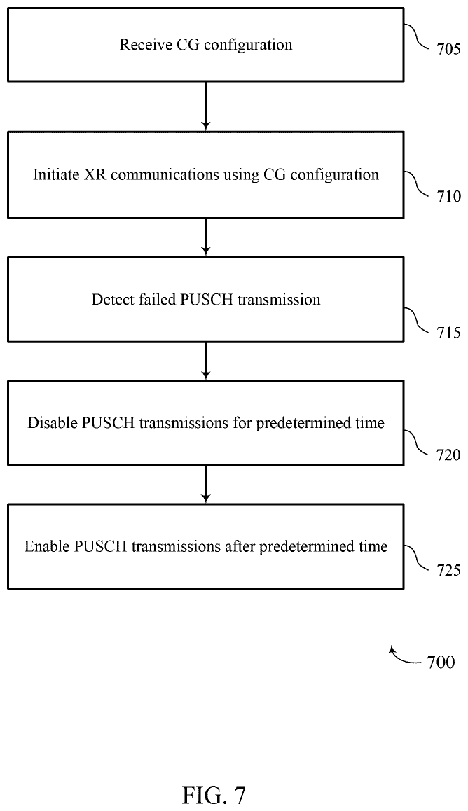

FIG. 7 illustrates a flowchart of a method 700 that supports efficient XR communications in accordance with aspects of the present disclosure. The operations of the method 700 may be implemented by a device or its components as described herein. For example, the operations of method 700 may be performed by a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 705, the method may include receiving a CG configuration. The operations of 705 may be performed in accordance with examples as described herein. In some implementations, aspects of the operations of 705 may be performed by a device as described with reference to FIG. 1.

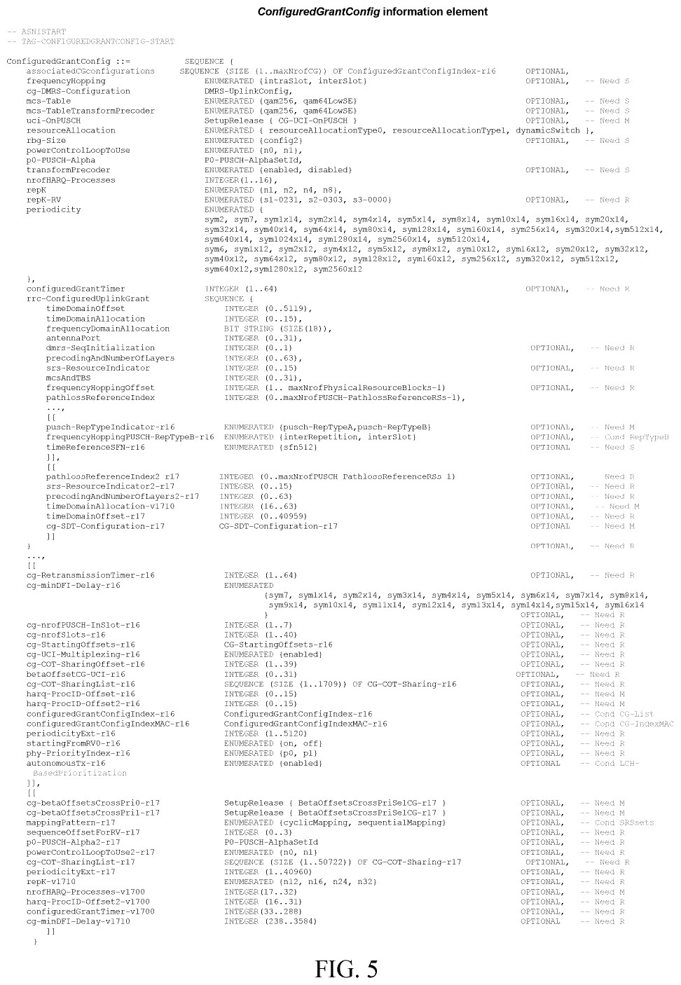

According to one embodiment, an uplink configured grant (CG) configuration includes a set of associated CG configurations. According to an embodiment, a CG configuration, e.g. IE ConfiguredGrant-Config, contains a new field which configures, if present, a list of identifiers, identifying associated CG configurations. An example of such an IE is provided in FIG. 5.

In one example, the network configures a set of associated CG configurations based on signaling information received from the Core Network, e.g. SMF. According to one implementation, the information of associated CG configurations, which may be derived from the information of associated service flows provided by the Core network, is used by the UE 104 to enhance power saving for XR applications as well as provide capacity gains.

At 710, the method may include initiating XR communications using the CG configuration received at 705. The operations of 710 may be performed in accordance with examples as described herein. In some implementations, aspects of the operations of 710 may be performed by a device as described with reference to FIG. 1.

At 715, the method may include detecting a failed PUSCH transmission. The operations of 715 may be performed in accordance with examples as described herein. In some implementations, aspects of the operations of 715 may be performed by a device as described with reference to FIG. 1.

Some of the reasons for a failed PUSCH transmission are different from the failed PDSCH transmission occasions at 315. For example, a PUSCH transmission failure may be caused by hardware or software, including failure of a codec to perform operations in a timely or accurate manner, or jitter. In some instances, the failure of a PUSCH transmission may be due to the lack of data available for transmission.

In some XR communications, the packet arrival rate is determined by the frame generation rate, e.g., 60 fps. Accordingly, the average packet arrival periodicity is given by the inverse of the frame rate, e.g., 16.6667 ms=1/60 fps. The periodic arrival without jitter gives the arrival time at gNB for packet with index k (=1, 2, 3 . . . ) as

$$k / F * 1000 [ ms ] ,$$

where F is the given frame generation rates (per second). This periodic packet arrival implicitly assumes fixed delay contributed from network side including fixed video encoding time, fixed network transfer delay, etc.

However, in a real system, the varying frame encoding delay and network transfer time introduces jitter in packet arrival time at a gNB. In this model, the jitter is modelled as a random variable added on top of periodic arrivals. The jitter follows truncated Gaussian distribution with certain statistical parameters.

The given parameter values and considered frame generation rates (60 or 120 in this model) ensure that packet arrivals are in order (i.e., arrival time of a next packet is always larger than that of the previous packet). Thus, the periodic arrival with jitter gives the arrival time for packet with index k (=1, 2, 3 . . . ) as

$$offset + k / F * 1000 + J [ ms ] ,$$

where F is the given frame generation rates (per second) and J is a random variable capturing jitter. Actual traffic arrival timing of traffic for each UE 104 could be shifted by the UE specific arbitrary offset. Accordingly, jitter may cause PUSCH transmissions to fail to be delivered in a timely manner.

At 720, the method may include disabling PUSCH transmissions for a predetermined time, and at 725, the method may include enabling PUSCH transmissions after the predetermined time. The operations of 720 and 725 may be performed in accordance with examples as described herein. In some implementations, aspects of the operations of 720 and 725 may be performed by a device as described with reference to FIG. 1.

According to one embodiment, a UE 104 temporarily disables PUSCH transmissions on CG resources of associated CG configurations at 720 when a CG PUSCH transmissions on a CG resource of one of the group of associated CG configurations failed. Assuming that different traffic flows (LCHs/DRBs) of a multi-flow XR application, e.g. multi-modal application, are mapped to different associated CG configurations, the UE 104 temporarily stops the uplink transmission of the other associated CG configurations when UE has not transmitted a MAC PDU on one of the CG resources of the group of associated CG configurations, e.g. due to the fact that there was no data available for transmission. When data of one of the input signals of a multi-modal application has not been transmitted in the uplink, there is little or no benefit in transmitting data of the other input signals of the XR applications. Instead, a UE 104 configured according to embodiments of the present disclosure can save power by not even transmitting the other associated data, such that either all the input signals are transmitted or none of them. In one example the UE discards the data which was intended for transmission on the disabled CG resources.

The above embodiments discussed with respect to process 300 provide details on how long UE can disable reception of associated SPS configurations in the context of the predetermined time, including using a timer, waiting for a next instance of a primary XR flow transmission, waiting for the next CG period, and waiting for a next transmission occasion of a failed flow. Those embodiments apply to the predetermined time of process 700 as well.

The above embodiments are not limited to cases where no PDSCH was detected on a SPS transmission occasion or no UL data was available for a CG PUSCH transmission, but can be applied to cases where the PDSCH reception on a SPS occasion and respectively the UL transmission on a CG resource was not successful, e.g. PDSCH/CG PUSCH was not correctly received. Accordingly, embodiments of the present disclosure apply to cases where resources are not successfully received by the target entity, regardless of the cause.

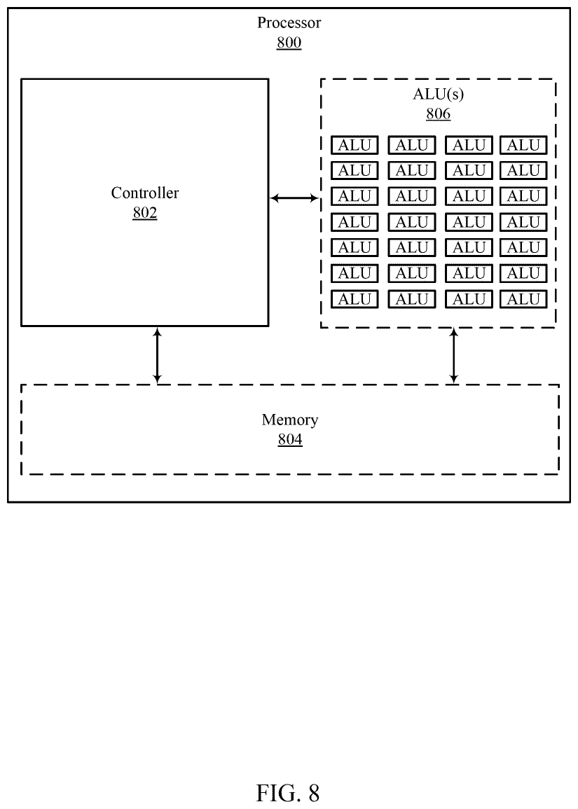

FIG. 8 illustrates an example of a processor 800 that supports efficient XR communications in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, such as L1/L2/L3 cache. Additionally, or alternatively, the processor 800 may optionally include one or more arithmetic-logic units (ALUs) 800. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementation, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, and the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 800 may be configured to support various operations in accordance with examples as described herein. In some implementations, the one or more ALUs 800 may reside within or on a processor chipset (e.g., the processor 800). In some other implementations, the one or more ALUs 800 may reside external to the processor chipset (e.g., the processor 800). One or more ALUs 800 may perform one or more computations such as addition, subtraction, multiplication, and division on data. For example, one or more ALUs 800 may receive input operands and an operation code, which determines an operation to be executed. One or more ALUs 800 be configured with a variety of logical and arithmetic circuits, including adders, subtractors, shifters, and logic gates, to process and manipulate the data according to the operation. Additionally, or alternatively, the one or more ALUs 800 may support logical operations such as AND, OR, exclusive-OR (XOR), not-OR (NOR), and not-AND (NAND), enabling the one or more ALUs 800 to handle conditional operations, comparisons, and bitwise operations.

The processor 800 may support wireless communication in accordance with examples as disclosed herein. The processor 800 may be configured to or operable to support a means for efficient XR communications.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first downlink semi-persistent scheduling configuration over radio resource control signaling,
wherein the first semi-persistent scheduling configuration includes a set of identifiers that identify at least one other downlink semi-persistent scheduling configuration associated with the first downlink semi-persistent scheduling configuration.

2. The UE of claim 1, wherein the processor is further configured to:
detect a failure to receive a physical downlink shared channel (PDSCH) transmission occasion of the first semi-persistent scheduling configuration; and
in response to the detected failure, disable decoding of at least one PDSCH transmission on a semi-persistent scheduling transmission occasion of the at least one other downlink semi-persistent scheduling configuration identified by the set of identifiers for a predetermined time period.

3. The UE of claim 2, wherein the processor is further configured to cause the UE to:
enable decoding of the of semi-persistent scheduling transmission occasions of the at least one other downlink semi-persistent scheduling configuration identified by the set of identifiers after the predetermined time period.

4. The UE of claim 3, wherein the predetermined time period is the next occurrence of a PDSCH transmission of the first semi-persistent scheduling configuration.

5. The UE of claim 3, wherein the first semi-persistent scheduling configuration designates a primary semi-persistent scheduling configuration and at least one secondary semi-persistent scheduling configuration, and the predetermined time period is the next occurrence of a transmission of the primary semi-persistent scheduling configuration.

6. The UE of claim 5, wherein the processor is further configured to cause the UE to disable decoding all PDSCH transmission occasions for the at least one secondary semi-persistent scheduling configuration after detecting a failure of a PDSCH transmission occasion of the primary semi-persistent scheduling configuration for the predetermined time period.

7. The UE of claim 2, wherein the processor is further configured to detect the failure to receive the PDSCH transmission occasion when the UE does not detect a PDSCH transmission on a semi-persistent transmission occasion of the first semi-persistent scheduling configuration.

8. The UE of claim 1, wherein each configuration of the first semi-persistent scheduling configuration and the at least one other downlink semi-persistent scheduling configuration associated with the first semi-persistent scheduling configuration are for a mixed reality (XR) communication.

9. The UE of claim 8, wherein each semi-persistent scheduling configuration is associated with a different sensory channel.

10. The UE of claim 9, wherein the different sensory channels include a video channel and an audio channel.

11. A processor for wireless communication, comprising:
at least one memory; and
a controller coupled with the at least one memory and configured to cause the controller to:
receive a first downlink semi-persistent scheduling configuration over radio resource control signaling,
wherein the first semi-persistent scheduling configuration includes a set of identifiers that identify at least one other downlink semi-persistent scheduling configuration associated with the first downlink semi-persistent scheduling configuration.

12. The processor of claim 11, wherein the controller is further configured to:
detect a failure to receive a physical downlink shared channel (PDSCH) transmission occasion of the first semi-persistent scheduling configuration; and
in response to the detected failure, disable decoding of at least one PDSCH transmission on a semi-persistent scheduling transmission occasion of the at least one other downlink semi-persistent scheduling configuration identified by the set of identifiers for a predetermined time period.

13. The processor of claim 12, wherein the controller is further configured to cause the controller to:
enable decoding of the of semi-persistent scheduling transmission occasions of the at least one other downlink semi-persistent scheduling configuration identified by the set of identifiers after the predetermined time period.

14. The processor of claim 13, wherein the predetermined time period is the next occurrence of a PDSCH transmission of the first semi-persistent scheduling configuration.

15. The processor of claim 13, wherein the first semi-persistent scheduling configuration designates a primary semi-persistent scheduling configuration and at least one secondary semi-persistent scheduling configuration, and the predetermined time period is the next occurrence of a transmission of the primary semi-persistent scheduling configuration.

16. The processor of claim 15, wherein the controller is further configured to cause the controller to disable decoding all PDSCH transmission occasions for the at least one secondary semi-persistent scheduling configuration after detecting a failure of a PDSCH transmission occasion of the primary semi-persistent scheduling configuration for the predetermined time period.

17. The processor of claim 12, wherein the controller is further configured to detect the failure to receive the PDSCH transmission occasion when the controller does not detect a PDSCH transmission on a semi-persistent transmission occasion of the first semi-persistent scheduling configuration.

18. The processor of claim 11, wherein each configuration of the first semi-persistent scheduling configuration and the at least one other downlink semi-persistent scheduling configuration associated with the first semi-persistent scheduling configuration are for a mixed reality (XR) communication.

19. A method performed by a user equipment (UE), the method comprising:
receiving a first downlink semi-persistent scheduling configuration over radio resource control signaling,
wherein the first semi-persistent scheduling configuration includes a set of identifiers that identify at least one other downlink semi-persistent scheduling configuration associated with the first downlink semi-persistent scheduling configuration.

20. The method of claim 19, further comprising:
detecting a failure to receive a physical downlink shared channel (PDSCH) transmission occasion of the first semi-persistent scheduling configuration; and
in response to the detected failure, disabling decoding of at least one PDSCH transmission on a semi-persistent scheduling transmission occasion of the at least one other downlink semi-persistent scheduling configuration identified by the set of identifiers for a predetermined time period.
